(19) United States
(12) Patent Application Publication
(10) Pub. No.: US 2007/0150266 A1
(43) Pub. Date: Jun. 28, 2007

(54) Search system and method thereof for searching code-vector of speech signal in speech encoder

(75) Inventors: Sheng-Lung Li, Taipei Shien (TW); Hsien-Ming Tsai, Chiali Township (TW)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Quanta Computer Inc.

(21) Appl. No.: 11/317,979

(22) Filed: Dec. 22, 2005

(51) Int. Cl. G10L 19/12

(52) U.S. Cl. 704/223

(57) ABSTRACT

The present invention provides a method for searching a target code-vector of a speech signal in a speech encoder. The target code-vector defines a plurality of pulse positions and includes a plurality of pulses each assignable to the pulse positions of the code-vector. The pulse positions are distributed to a plurality of tracks. The search method includes the following steps: evaluating a hit function for each pulse position, determining a plurality of pulse combinations in each track, evaluating a combinational hit function for each pulse combination, selecting the pulse combination with the highest value of the combinational hit function in each track to form a default code-vector, forming a candidate code-vector, according to the candidate code-vector and the default code-vector, performing a code-vector update procedure to determine the target code-vector.

### BACKGROUND OF THE INVENTION

1. Field of the Invention

This present invention relates generally to a system and the method thereof for searching a code-vector and, more particularly, to a system and method for searching a target code-vector of a speech signal in a speech encoder.

2. Description of the Prior Art

The well-known adaptive multi-rate (AMR) speech codec is established by the Third Generation Partnership Project (3GPP). According to AMR specification, 3GPP TS 26.090, there are totally eight low bit-rate encoding modes, i.e. 12.2, 10.2, 7.95, 7.40, 6.70, 5.90, 5.15, and 4.75 kbit/s. The core technology of AMR speech codec is the so-called Algebraic Code-Excited Linear-Prediction, hereafter referred to as ACELP.

Referring to FIG. 1, a general ACELP speech encoder 10 in the art is illustrated. The ACELP speech encoder 10 includes a preprocessor 12, a linear prediction analyzer 14, an adaptive codebook searcher 16 and an algebraic codebook searcher 18. The preprocessor 12 includes a high-pass filter 20. Firstly, a speech signal s(n) is inputted into the preprocessor and the low frequency components of s(n) are filtered out by the high-pass filter 20. Next, s(n) is passed to the linear prediction analyzer 14 to generate an excitation signal x(n). The excitation signal x(n) is a combination of a periodic excitation signal and an algebraic code excitation signal. The excitation signal x(n) is passed through the adaptive codebook searcher 16 to obtain the periodic excitation signal, and calculate the difference between the excitation signal x(n) and the periodic excitation signal to obtain the target signal x₂(n), then through the algebraic codebook searcher to obtain the algebraic code-vector.

In the ACELP speech encoder 10, the algebraic codebook searcher 18 is used to find a refined code-vector cₖ and its gain g_{c} so as to minimize the mean-square weighted error εₖ between the synthesized speech signal and a target signal x₂. The mean-square weighted error εₖ is determined by the following equation:

$${ɛ}_{k} = {\vert ( {x}_{2} - {g}_{c} {H}^{ρ} \cdot {{c}^{ρ}}_{k} ) \vert}^{2} , \qquad ( 1 )$$

where cₖ is the code-vector at index k in the algebraic codebook. According to AMR specification, 3GPP TS 26.090, the refined code-vector cₖ will result in a larger decision score Aₖ. The decision score Aₖ is determined by the following equation:

$${A}_{k} = \frac{{( {C}_{k} )}^{2}}{{E}_{DK}} = \frac{{( {d}^{t}}^{ρ} \cdot {{{c}_{k} )}^{ρ}}^{2}}{{{c}_{k}^{t}}^{ρ} \cdot {Φ}^{ρ} \cdot {{c}_{k}}^{ρ}} , \qquad ( 2 )$$

where d=H^{t} x₂ is the correlation function between the target signal x₂ and the impulse response h(n) of the linear prediction analyzer, H is the lower triangular Toepliz convolution matrix with diagonal h(0) and lower diagonals h(1), . . . , h(39), and Φ=H^{t}H is the auto-correlation function of h(n).

Because the algebraic codebook search procedure takes up most computations of the ACELP speech encoder 10, many efficient code-vector searching algorithms have been proposed in the art to reduce the computational complexity of algebraic codebook search and to improve the speech quality, e.g. U.S. Pat. No. 5,701,392, U.S. Pat. No. 6,714,907, Hochong Park, “Efficient Codebook Search Method for EVRC Speech Codec”, IEEE Signel Processing Letters, vol. 7, no. 1, 2000 Hochong Park, Younchang Choi and Doyoon Lee, “Efficient Codebook Search Method for ACELP Speech Codecs”, IEEE, 2002 etc. The performance measurements of algebraic codebook search include the computational complexity and speech quality. On the one hand, the computational complexity can be measured by the processing time needed for the ACELP speech encoder 10. On the other hand, the speech quality can be measured by the value of Perceptual Evaluation of Speech Quality (PESQ). PESQ is established by the ITU Telecommunication Standardization Sector (ITU-T) in specification ITU-T P.862. PESQ takes advantage of an objective hearing model to estimate the Mean Opinion Score (MOS). The PESQ MOS ranges from −0.5 to 4.5. Higher values of PESQ stand for better speech quality.

According to AMR standard of 3GPP, the algebraic codebook search procedure takes the depth-first tree searching algorithm. The details of the search procedure are described in AMR specification, 3GPP TS 26.090, and U.S. Pat. No. 5,701,392.

Referring to FIG. 2, this figure shows the distribution of pulse positions of an exemplary code-vector in 12.2 kbit/s mode of AMR standard. Each code-vector consists of ten pulses based on forty pulse positions in the algebraic codebook, where the pulse positions are indexed by an integer n ranging from 0 to 39, and the pulses are represented by Pᵢ, i=0, . . . , 9. As indicated in FIG. 2, the 10 pulses are uniformly distributed to 40 positions among 5 tracks Tᵢ, i=0, 1, . . . , 4. As a result, each pulse possibly appears at the eight positions in its assigned track. Take pulse P₀ as an example, P₀ might appear at the eight pulse positions of indexes 0, 5, 10, 15, 20, 25, 30, and 35. The algebraic codebook search procedure finds 10 (pulses among) out of the 40 pulse positions to constitute a refined code-vector cₖ and achieve a higher decision score Aₖ, i.e. lower mean-square weighted error εₖ between the synthesized speech signal and a target signal x₂.

Referring to FIG. 3, a flowchart of the depth-first tree searching algorithm in the art according to AMR standard is illustrated. According to AMR specification, taking the 12.2 kbit/s encoding mode as an example, the steps of the depth-first tree searching algorithm are described below. Firstly, the search procedure is started up (S100). Then, the values of a hit function b(n) are evaluated at each of the pulse positions (S102). The hit function b(n) is given by the following equation:

$$b ( n ) = \frac{{res}_{LTP} ( n )}{\sqrt{{\sum }_{i = 0}^{39} {res}_{LTP} ( i ) {res}_{LTP} ( i )}} + \frac{d ( n )}{\sqrt{{\sum }_{i = 0}^{39} d ( i ) d ( i )}} , n = 0 , 1 , 2 , … , 39 \qquad ( 3 )$$

where res_{LTP}(n) is the long-term prediction residual at pulse position n, d(n) is the correlation function between the target signal x₂(n) and the impulse response h(n) of the linear prediction analyzer at pulse position n.

Next, pulse P₀ is assigned to the position with the largest absolute value of b(n) (S104) and pulse P₁ is assigned to the position with the second largest absolute value of b(n) in the tracks other than P₀'s track (S106). At step S108, the next one and two tracks of P₁'s track are searched for the positions of pulse P₂ and P₃ in accordance with the decision scores Aₖ. For example, if P₁ lies within track T₄, the next one track (i.e. T₀) and the second next track (i.e. T₁) are searched for the positions of pulse P₂ and P₃. The same rule is applied to following steps. At step S110, the next one and two tracks of P₃'s track are searched for the positions of pulse P₄ and P₅ in accordance with the decision scores Aₖ. At step S112, the next one and two tracks of P₅'s track are searched for the positions of pulse P₆ and P₇ in accordance with the decision scores Aₖ. At step S114, the next one and two tracks of P₇'s track are searched for the positions of pulse P₈ and P₉ in accordance with the decision scores Aₖ. Following the preceding steps, step S116 is performed to check if the search procedure has achieved a predetermined number of iterations. If Yes in step S116, proceed with step S118. Otherwise, return to step S106. Afterward, the pulses P₀, P₉ are determined to be at the pulse positions which result in the largest decision score to form a target code-vector (S118), and then the searching algorithm is terminated (S120).

According to the abovementioned algorithm, if the predetermined number of iterations is four, it takes 4*(8*8+8*8+8*8+8*8)=1024 search iterations for the depth-first tree searching algorithm to determine the target code-vector.

FIG. 4 is a flowchart of the pulse replacement searching algorithm in the art. The pulse replacement searching algorithm cooperates with the depth-first tree searching algorithm to improve encoding quality. The steps of the pulse replacement searching algorithm are described as follows. Firstly, the searching algorithm is started up (S200). Then, a default code-vector is obtained by utilizing the depth-first tree searching algorithm. The decision score of the default code-vector is also calculated (S202). The step of S204 is then performed to compute the contribution scores of each pulse position in the default code-vector. Next, step S206 is performed to locate the pulse position with lowest contribution score and the track thereof. From the other pulse positions in the same track, a candidate pulse position is selected to temporarily substitute for the pulse position with lowest contribution score such that a candidate code-vector resulting from the candidate pulse position has a higher decision score than from other pulse positions (S208). The step of S210 is performed to determine if the decision score of the candidate code-vector is less than that of the default code-vector. If the determination result is affirmative, the current default code-vector is outputted as the target code-vector and step S216 is performed. Otherwise, proceed with step S212. The step of S212 is to substitute the candidate pulse position for the pulse position with the lowest decision score and update the default code-vector with the candidate code-vector. Afterward, step S214 is performed to determine if the substitution of pulse positions has exceeded a predefined times. If the determination result is affirmative, proceed with step S216. Else, go back to step S204. Finally, the searching algorithm is terminated (S216).

Referring to FIG. 5, a flowchart of the sub-codebook searching algorithm disclosed in U.S. Pat. No. 6,714,907 is illustrated. The sub-codebook searching algorithm includes the following steps. Firstly, the searching algorithm is started up (S300). Then, the depth-first tree searching algorithm is applied to search the first sub-codebook for the best default code-vector. The decision score of the default code-vector is calculated (S302). The depth-first tree searching algorithm is applied to search the next sub-codebook for the best candidate code-vector. The decision score of the candidate code-vector is also calculated (S304). The decision scores of the default code-vector and the candidate code-vector are compared to determine a better decision score and the corresponding code-vector (S306). The step of S308 is performed to determine if the last sub-codebook has been searched. If the determination result is affirmative, proceed with step S310. Else, go back to perform step S304. The step of S310 performs the pulse replacement searching algorithm on the code-vector with the best decision score to obtain the finalized code-vector. Finally, the searching algorithm is terminated (S312).

According to the aforementioned methods in the art, it can be concluded that the algebraic codebook search procedure takes up most computations of the ACELP speech encoder. Take the AMR 12.2 kbit/s encoding mode as an example, the depth-first tree searching algorithm taken by the algebraic codebook searcher occupies 40% of the overall computational cost, resulting from the 1024 search iterations for ensuring the encoding quality. In other words, the excessive search iterations of the depth-first tree searching algorithm result in extremely high computational cost. However, techniques for improving encoding quality in the art, such as the pulse replacement searching algorithm and sub-codebook searching algorithm, are mostly based on the depth-first tree searching algorithm, causing even higher computational cost.

Accordingly, the main objective of the present invention is to provide a system and method for searching a target code-vector of a speech signal in a speech encoder so as to resolve the aforementioned problems.

### SUMMARY OF THE INVENTION

One objective of the invention is to provide a system and method for searching a target code-vector of a speech signal in a speech encoder as well as lowering the computational complexity and ensuring the encoding quality.

The search method of the invention is used for searching a target code-vector of a speech signal in a speech encoder. The speech signal includes a plurality of code-vectors, which each defines a plurality of pulse positions individually and includes a plurality of pulses each assignable to the pulse positions of the code-vector. The pulse positions are distributed to a plurality of tracks. The search method of the invention includes the following steps:

(a) for each of the pulse positions, evaluating a respective value of a hit function corresponding to each pulse position;

(b) determining a plurality of pulse combinations in each of the tracks in accordance with the pulse positions and pulses in each of the tracks;

(c) for each of the pulse combinations, evaluating a respective value of a combinational hit function corresponding to each pulse combination in accordance with the value of the hit function corresponding to each of the pulse positions;

(d) sorting the pulse combinations in each of the tracks in accordance with the value of the combinational hit function corresponding to each of the pulse combinations, in each of the tracks, selecting the pulse combination which has the largest value of the combinational hit function to be a default pulse combination, sorting the other pulse combinations into an ordered sequence in descending order by the values of the combinational hit function;

(e) according to the default pulse combination in each of the tracks, forming a default code-vector and calculating a decision score of the default code-vector;

(f) from the ordered sequence, selecting the next pulse combination to be a candidate pulse combination and to temporarily substitute for the default pulse combination in the same track, forming a candidate code-vector and calculating the decision score of the candidate code-vector; and

(g) according to the decision scores of the candidate code-vector and the default code-vector, performing a code-vector update procedure to determine the target code-vector.

According to the present invention, the code-vector search method not only lowers the computational complexity by reducing the iterations for searching a refined code-vector, but enlarges the decision score and minimizes the errors between the original and encoded speech signal so as to ensure the encoding quality.

The advantage and spirit of the invention may be understood by the following recitations together with the appended drawings.

### BRIEF DESCRIPTION OF THE APPENDED DRAWINGS

FIG. 1 is a schematic diagram showing the function blocks of an ACELP speech encoder in the art.

FIG. 2 illustrates a table summarizing the distribution of pulse positions of an exemplary code-vector according to 12.2 kbit/s mode of AMR standard.

FIG. 3 is a flowchart showing the depth-first tree searching algorithm in the art according to AMR standard.

FIG. 4 is a flowchart showing the pulse replacement searching algorithm in the art.

FIG. 5 is a flowchart showing the sub-codebook searching algorithm in the art.

FIG. 6 bases on the depth-first tree searching algorithm to illustrate the hit probability distributions of pulses, which are sorted by the hit function values corresponding to the pulse positions in each track.

FIG. 7 is a schematic diagram showing the function blocks of a search system according to the invention.

FIG. 8 is a schematic diagram showing the function blocks of the seventh device shown in FIG. 7.

FIG. 9 illustrates a table summarizing the hit function values corresponding to the pulse positions of an exemplary code-vector.

FIG. 10 illustrates all possible pulse combinations and the corresponding combinational hit function values of an exemplary code-vector according to a first embodiment of the invention.

FIG. 11A depicts a default code-vector determined by the search system according to the first embodiment of the invention.

FIG. 11B depicts an ordered sequence determined by the search system according to the first embodiment of the invention.

FIG. 12 illustrates all possible pulse combinations and the corresponding combinational hit function values of an exemplary code-vector according to a second embodiment of the invention.

FIG. 13A depicts a default code-vector determined by the search system according to the second embodiment of the invention.

FIG. 13B depicts an ordered sequence determined by the search system according to the second embodiment of the invention.

FIG. 14 is a flowchart showing the search method for searching a target code-vector of a speech signal in a speech encoder according to the invention.

FIG. 15 is a compare list for comparing the first embodiment, the second embodiment of the invention with the sub-codebook searching algorithm in the art according to AMR standard.

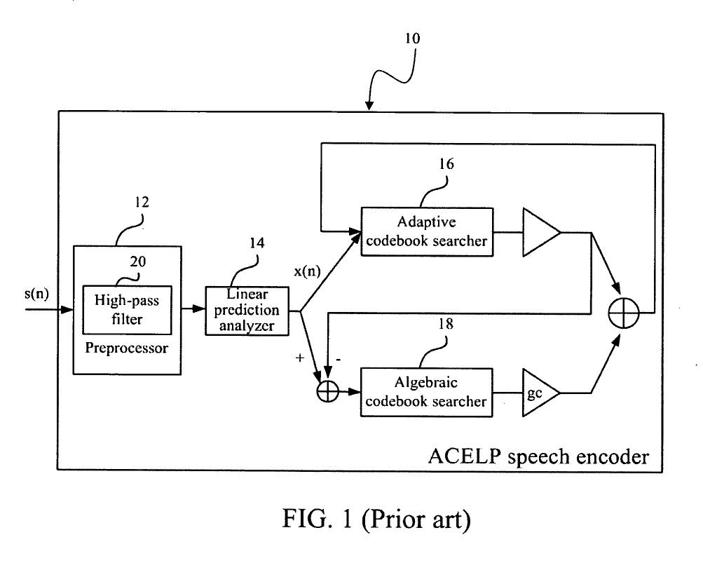

### DETAILED DESCRIPTION OF THE INVENTION

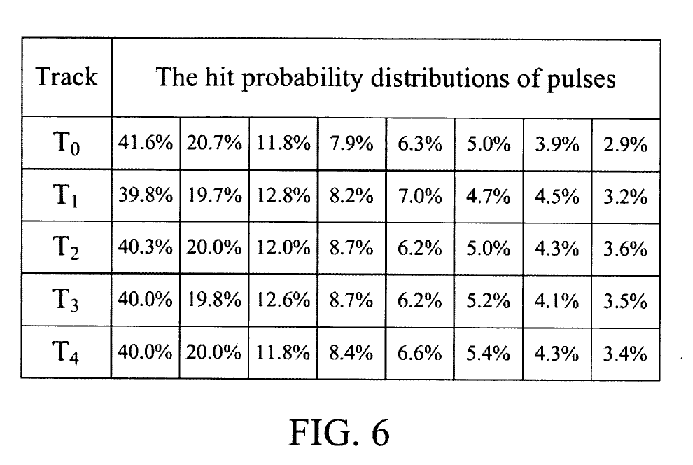

Referring to FIG. 6, FIG. 6 bases on the depth-first tree searching algorithm to illustrate the hit probability distributions of pulses, which are sorted by the hit function values corresponding to the pulse positions in each track. The experimental speech signal depicted in FIG. 6 includes 616 speech frames, forming a signal of 12.32 seconds in length. The speech signal includes 5 tracks and 4928 pulses occur in each track. The probability that a pulse occurs at a specific pulse position is proportional to the hit function value corresponding to the pulse position. As shown in FIG. 6, in track T₀, the pulse position with largest hit function value has the highest hit probability (41.6%). The hit probability decreases as well as the hit function values corresponding to the pulse positions. Accordingly, the present invention determines the combinational hit function of each combination of pulse position according to the hit function corresponding to each pulse position, and forecasts a better ordered sequence of pulse combination to reduce the computational complexity of algebraic codebook search.

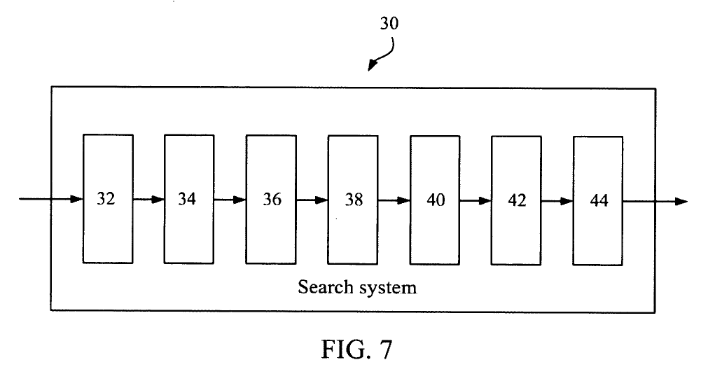

Referring to FIG. 7, FIG. 7 is a schematic diagram showing the function blocks of a code-vector search system 30 according to the invention. The search system 30 of the invention is used for searching a target code-vector of a speech signal in a speech encoder (not shown in FIG. 7). The speech signal includes a plurality of code-vectors, which each defines a plurality of pulse positions individually and includes a plurality of pulses each assignable to the pulse positions of the code-vector. The pulse positions are distributed to a plurality of tracks. The search system 30 includes a first device 32, a second device 34, a third device 36, a fourth device 38, a fifth device 40, a sixth device 42 and seventh device 44.

The first device 32 may be a processor or calculator, mainly for evaluating a respective value of a hit function corresponding to each pulse position. The second device 34 may be a processor or controller, mainly for determining a plurality of pulse combinations in each of the tracks in accordance with the pulse positions and pulses in each of the tracks. The third device 36 may be a processor or calculator, mainly for evaluating a respective value of a combinational hit function corresponding to each pulse combination in accordance with the hit function value corresponding to each of the pulse positions. The fourth device 38 may be a processor or controller, mainly for sorting the pulse combinations in each of the tracks in accordance with the combinational hit function values corresponding to each of the pulse combinations. In each of the tracks, the fourth device 38 selects the pulse combination which has the largest value of the combinational hit function to be a default pulse combination, and sorts the other pulse combinations into an ordered sequence in descending order by the value of the combinational hit functions. The fifth device 40 may be a processor or calculator, mainly for forming a default code-vector in accordance with the default pulse combination in each of the tracks and calculating a decision score of the default code-vector. The sixth device 42 may be a processor or calculator, mainly for selecting the next pulse combination from the ordered sequence to be a candidate pulse combination and to temporarily substitute for the default pulse combination in the same track. The sixth device 42 forms a candidate code-vector and calculates the decision score of the candidate code-vector. The seventh device 44 may be a processor or controller, mainly for determining the target code-vector in accordance with the decision scores of the candidate code-vector and the default code-vector.

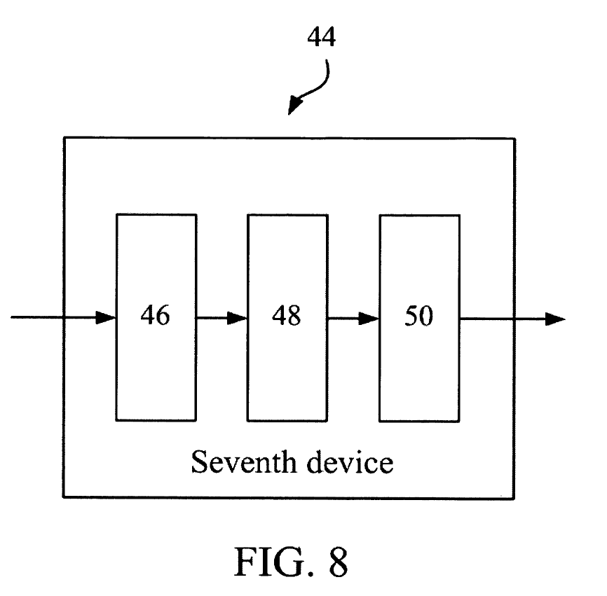

Referring to FIG. 8, FIG. 8 is a schematic diagram showing the function blocks of the seventh device 44 shown in FIG. 7. The seventh device 44 further includes a first module 46, a second module 48 and a third module 50. The first module 46 may be a processor or controller, mainly for determining if the decision score of the candidate code-vector is less than the decision score of the default code-vector. The second module 48 may be a processor or controller, mainly for updating the default code-vector with the candidate code-vector. The third module 50 may be a processor or controller, mainly for examining if the current search progress satisfies a predetermined search condition. The search system 30 chooses the default code-vector to be the target code-vector and finishes searching when the current search progress satisfies the predetermined search condition.

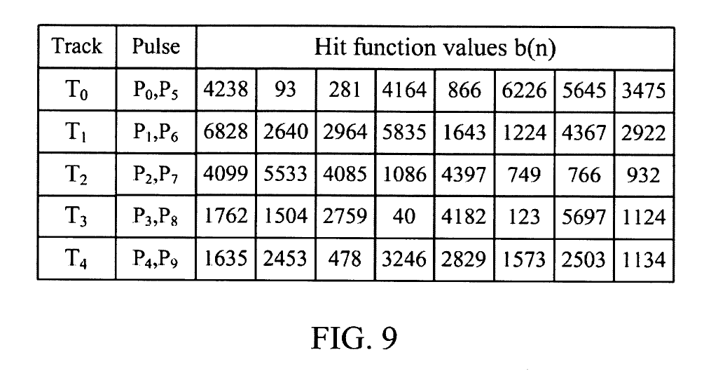

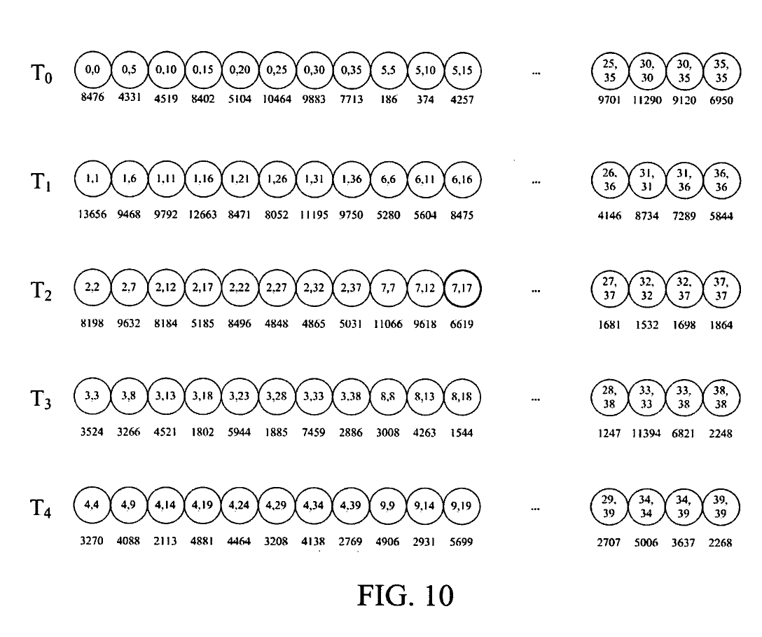

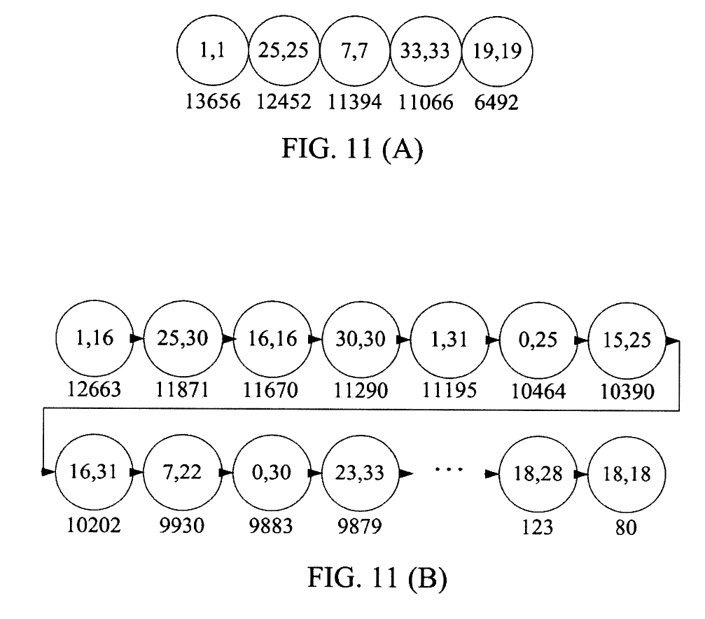

Please refer to FIGS. 9 through 11B. FIG. 9 illustrates a table summarizing the hit function values corresponding to the pulse positions of an exemplary code-vector. FIG. 10 illustrates all possible pulse combinations and the corresponding combinational hit function values of an exemplary code-vector according to a first embodiment of the invention. FIG. 11A depicts a default code-vector determined by the search system according to the first embodiment of the invention. FIG. 11B depicts an ordered sequence determined by the search system according to the first embodiment of the invention. In the first embodiment of the invention, the value of the combination hit function corresponding to one of the pulse combination is the sum of the hit function values of the pulse positions corresponding to one pulse combination.

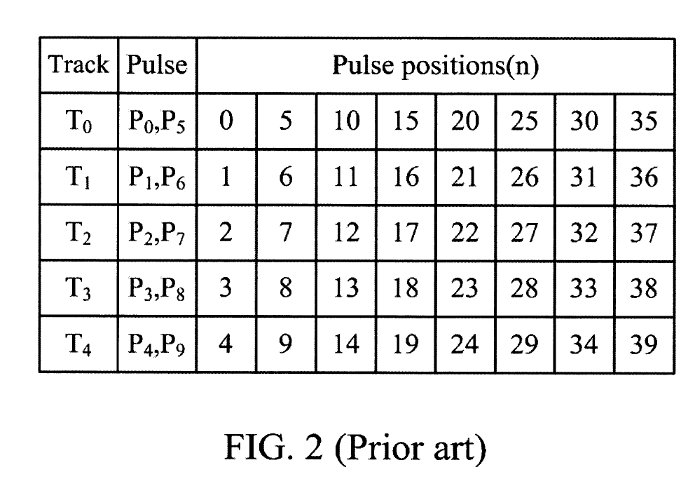

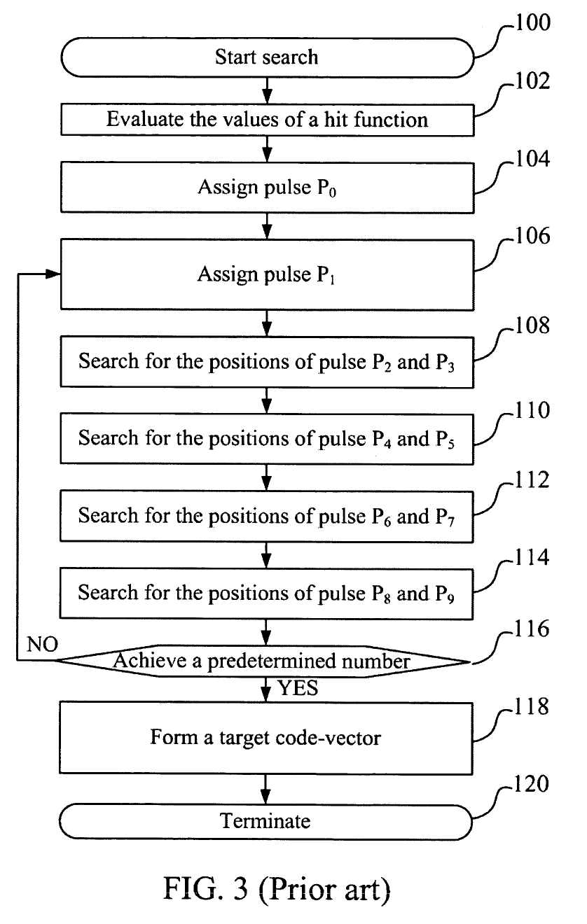

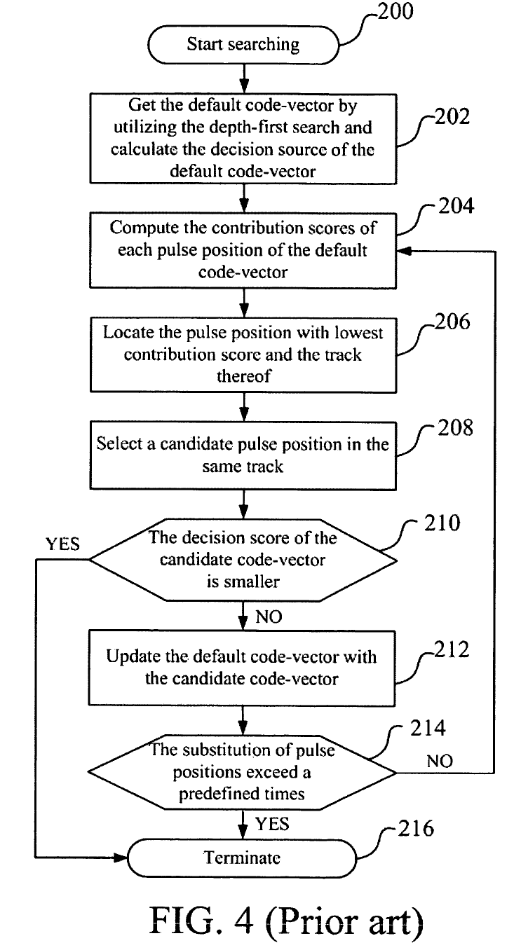

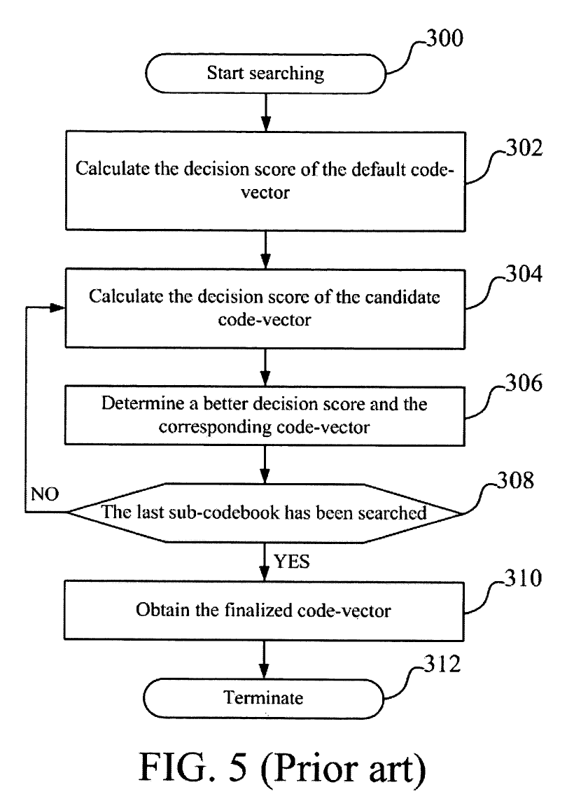

According to the first embodiment of the invention, the distribution of pulse positions of an exemplary code-vector according to 12.2 kbit/s mode of AMR standard is summarized in the table of FIG. 2. According to the aforementioned code-vector search system 30 of the invention, when the speech encoder receives a speech signal, the code-vector search system 30 activates to search the code-vector of the speech signal. The searching process of a target code-vector would be illustrated thereinafter with FIG. 7 and FIG. 8.

The first device 32 first evaluates a respective value of a hit function b(n) corresponding to each pulse position as shown in FIG. 9. The second device 34 determines the pulse combinations in each of the tracks in accordance with the pulse positions and pulses in each of the tracks. According to AMR specification, taking the 12.2 kbit/s encoding mode as an example, each track has two pulses in eight possible pulse positions (repeatable), the combination of pulse positions in each of the tracks therefore has C⁽⁸⁺¹⁾₂=36 possibilities, such as (0,0), (0,5), (0,10), (0,15) (0,20), (0,25), . . . , (35,35) in track T₀. The third device 36 evaluates a respective value of a combinational hit function corresponding to each pulse combination in accordance with the hit function value corresponding to each of the pulse positions. For example, the value of the combinational hit function corresponding to the pulse combination (n₁,n₂) is defined as the sum of the hit function values of the two pulse positions b(n₁)+b(n₂). The value of the combinational hit function corresponding to each of the pulse combination is marked below the pulse combination as shown in FIG. 10, such as the pulse combination (0,0), which corresponding value of the combinational hit function is b(0)+b(0)=8476. Afterwards, when the fourth device 38 sorts the pulse combinations in each of the tracks in accordance with the value of the combinational hit function corresponding to each of the pulse combinations, the pulse combinations respectively corresponding to the largest value of the combinational hit function in each of the tracks are (25,25) in track T₀ (1,1) in track T₁, (7,7) in track T₂, (33,33) in track T₃ and (19,19) in track T₄. The aforementioned five pulse combinations are the default pulse combination as FIG. 11(A) depicted. In this embodiment, other pulse combinations are sorted into an ordered sequence by the value of the combinational hit functions, such as (1,16), (25,30), (16,16), . . . , (18,28), (18,18) depicted in FIG. 11(B). The fifth device 40 forms a default code-vector (1,1,7,7,19,19,25,25,33,33) in accordance with the default pulse combination in each of the tracks and calculates a decision score A_{D} of the default code-vector. According to the ordered sequence, the sixth device 42 selects the next pulse combination (1,16) from the ordered sequence to be a candidate pulse combination and to temporarily substitute for the default pulse combination (1,1) in the corresponding track T₁. The sixth device 42 forms a candidate code-vector (1,7,7,16,19,19,25,25,33,33) and calculates the decision score A_{C} of the candidate code-vector. The first module 46 of the seventh device 44 determines if the decision score A_{C} of the candidate code-vector is less than the decision score A_{D} of the default code-vector. If the result is YES, the candidate pulse combination (1,16) could not substitute for the default pulse combination (1,1) to improve the speech quality; if the decision score A_{C} of the candidate code-vector is not less than the decision score A_{D} of the default code-vector, the second module 48 of the seventh device 44 would update the default pulse combination (1,1) with the candidate pulse combination (1,16); the default code-vector with (1,7,7,16,19,19,25,25,33,33), and the decision score A_{D} with the A_{C}. Finally, the third module 50 examines if the current search progress satisfies a predetermined search condition, and if yes, the default code-vector is chosen to be the target code-vector and the searching process is finished.

In this embodiment, as shown in FIG. 11(B), when the last pulse combination (18,18) is searched for, the searching process is stopped and the code-vector corresponding to the better decision score is required. It needs to be aware of that although searching till the last pulse combination of the ordered sequence is the predetermined search condition, some of the pulse combinations are not necessary to be searched for reducing the search time. It can be found out from the results in FIG. 6 that the hit probability decreases as well as the hit function values corresponding to the pulse positions. Therefore the ordered sequence can only include the pulse combinations whose corresponding hit function has higher value for saving the search time. In another word, the invention can further set a threshold, if the value of the combinational hit function corresponding to one of the pulse combination is less than the threshold, such as 5000, the pulse combination is eliminated from the ordered sequence. And, for example, if the ordered sequence only includes 35 pulse combinations, the pulse combinations whose corresponding combinational hit function with less value would be eliminated from the ordered sequence. Besides, the predetermined searching condition can be a predetermined number of search iterations or a predetermined search time.

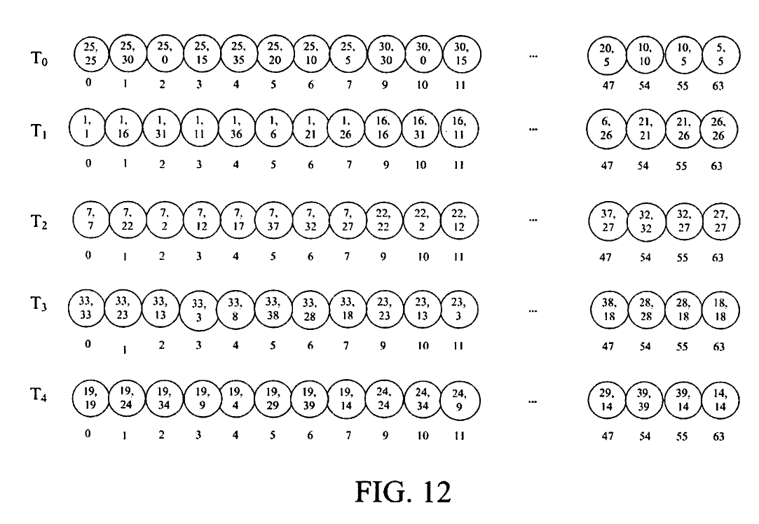

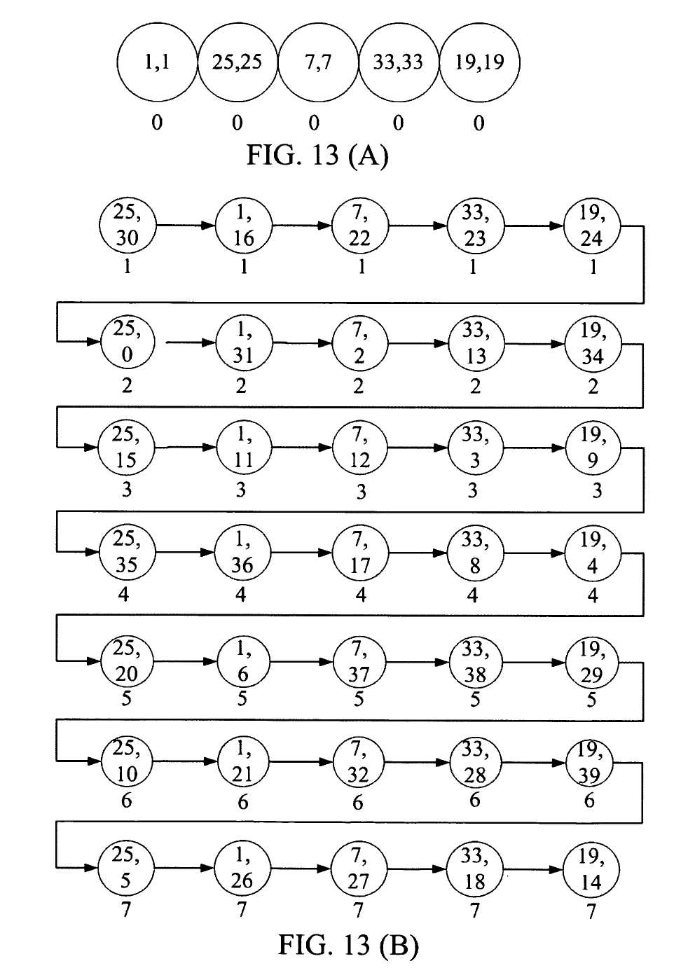

Please refer to FIGS. 12 through 13B. FIG. 12 illustrates all possible pulse combinations and the corresponding value of the combinational hit functions of an exemplary code-vector according to a second embodiment of the invention. FIG. 13A depicts a default code-vector determined by the search system according to the second embodiment of the invention. FIG. 13B depicts an ordered sequence determined by the search system according to the second embodiment of the invention. In the second embodiment of the invention, the value of the combination hit function corresponding to one of the pulse combination is an ordinal number determined by the hit function values of the pulse positions corresponding to the pulse combination.

According to the second embodiment of the invention, the distribution of pulse positions of an exemplary code-vector according to 12.2 kbit/s mode of AMR standard is summarized in the table of FIG. 2. The main difference between the first embodiment and the second embodiment is the definition of the value of the combinational hit function. In the first embodiment of the invention, the value of the combination hit function corresponding to one of the pulse combination is defined as the sum of the hit function values of the two pulse positions corresponding to the pulse combination. In this embodiment, the value of the combination hit function corresponding to one of the pulse combination is an ordinal number determined by the hit function values of the two pulse positions in the track corresponding to the pulse combination. That is to say, the value of the combination hit function corresponding to the pulse combination (n₁,n₂) is 8*O(b(n₁))+O(b(n₂)), wherein O(b(n₁)) is to indicate the order of the hit function value of the pulse position n₁ in the track, and b(n₁)>=b(n₂). In this embodiment, the bigger the hit function value b(n₁) or b(n₂) is, the smaller the value of the corresponding combination hit function is and the earlier the order is. As shown in FIG. 12, the pulse combination is in order of (25,25), (25,30), (0,25), . . . , (5,5) and so on in track T₀, wherein the value of the combination hit function corresponding to the pulse combination (25,25) is 0; the value of the combination hit function corresponding to the pulse combination (25,30) is 1, and the rest may be deduced by analogy. Therefore, when the fourth device 38 sorts the pulse combinations in each of the tracks in accordance with the value of the combinational hit function corresponding to each of the pulse combinations, the pulse combinations respectively corresponding to the first position of the combinational hit function in each of the tracks are (25,25) in track T₀, (1,1) in track T₁, (7,7) in track T₂, (33,33) in track T₃ and (19,19) in track T₄. The aforementioned five pulse combinations are the default pulse combination as FIG. 13(A) depicted. In this embodiment, the other pulse combinations is sorted into an ordered sequence by the positions of the track, such as (25,30), (1,16), (7,22), (33,23), (19,24), (25,0), (1,31), (7,2), . . . , (1,10), (7,27), (33,18), (19,14) shown in FIG. 13(B). It needs to be aware of that other pulse combinations are not listed in to the ordered sequence for saving the search time because the value of these combinational hit functions are too small. Appearing with the first embodiment, the second embodiment has different ordered sequence because the definition of the value of the combinational hit function is different from the first embodiment.

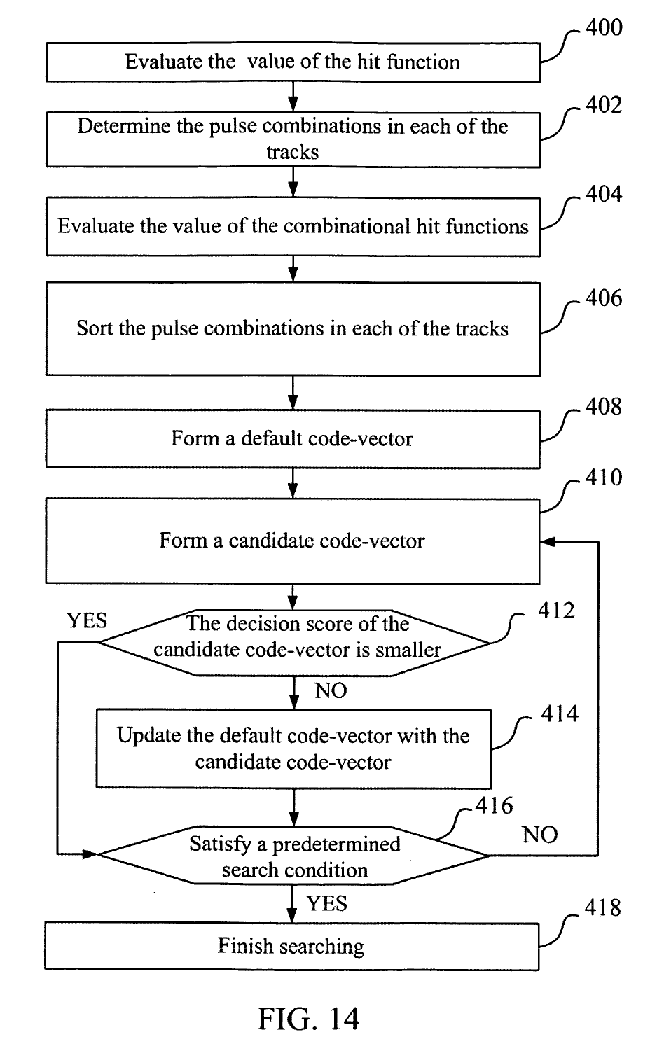

Referring to FIG. 14, FIG. 14 is a flowchart showing the search method for searching a target code-vector of a speech signal in a speech encoder according to the invention. The invention also provides a method for searching a target code-vector of a speech signal in a speech encoder. The speech signal includes a plurality of code-vectors, and each of the code-vectors defines a plurality of pulse positions individually and includes a plurality of pulses each assignable to the pulse positions of the code-vector. The pulse positions are distributed to a plurality of tracks. According to the invention, the steps of the method for searching a target code-vector of a speech signal in a speech encoder are described below. Firstly, for each of the pulse positions, a respective value of a hit function is evaluated corresponding to each pulse position (S400). Then, a plurality of pulse combinations in each of the tracks are determined in accordance with the pulse positions and pulses in each of the tracks (S402). For each of the pulse combinations, a respective value of a combinational hit function is evaluated corresponding to each pulse combination in accordance with the value of the hit function corresponding to each of the pulse positions (S404). Afterwards, the pulse combinations in each of the tracks are sorted in accordance with the value of the combinational hit function corresponding to each of the pulse combinations. In each of the tracks, the pulse combination which has the largest value of the combinational hit function is selected to be a default pulse combination, and the other pulse combinations are sorted into an ordered sequence in descending order by the values of the combinational hit function (S406). A default code-vector is formed and a decision score of the default code-vector is calculated according to the default pulse combination in each of the tracks (S408). The next pulse combination is selected from the ordered sequence to be a candidate pulse combination and to temporarily substitute for the default pulse combination in the same track to form a candidate code-vector, and the decision score of the candidate code-vector is calculated (S410). Step S412 is performed to determine if the decision score of the candidate code-vector is less than the decision score of the default code-vector, if YES, step S416 is performed, otherwise, step S414 is proceeded with. In step S414, the candidate pulse combination is substituted for the default pulse combination in the same track, and the default code-vector is updated with the candidate code-vector. Step S416 is performed to examine if the current search progress satisfies a predetermined search condition, if YES, step S418 is performed. Else, go back to perform step S410. In step S418, the default code-vector is chosen as the target code-vector and searching is finished.

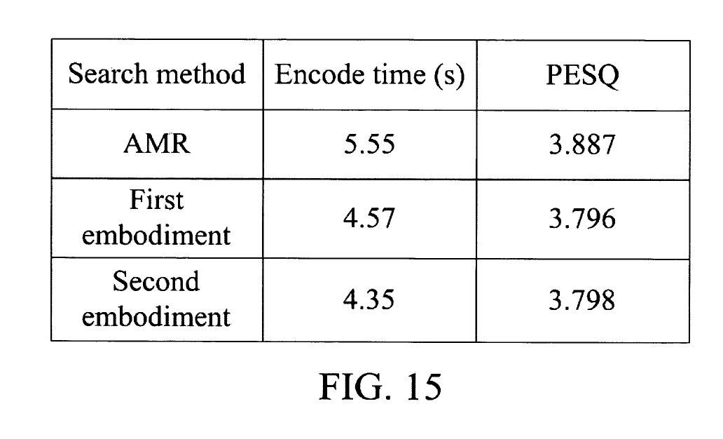

Referring to FIG. 15, FIG. 15 is a compare list for comparing the first embodiment, the second embodiment of the invention with the algebraic-codebook searching algorithm in the art according to AMR standard. The searching algorithm according to AMR standard searches for 1024 times, and the first embodiment and the second embodiment of the invention respectively search for 35 times. The result of the experiment shows that the experimental speech is 12.32 seconds in length; the AMR standard spends 5.55 seconds to encode, the first embodiment of the invention spends 4.57 seconds to encode, and the second embodiment of the invention spends 4.35 seconds to encode. Therefore, comparing with the AMR standard, the first embodiment of the invention reduces 17.1% of the overall computational time and the second embodiment of the invention reduces 22.7% of the overall computational time to encode the experimental speech, and the values of PESQ only decrease 0.091 and 0.089 and hard to tell by human's ear. Accordingly, the invention employs the pulse combination to substitute for the prior art not only lowers the computational complexity by reducing the iterations for searching a refined code-vector, but enlarges the decision score and minimizes the errors between the original and encoded speech signal so as to ensure the encoding quality.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for searching a target code-vector of a speech signal in a speech encoder, the speech signal comprising a plurality of code-vectors, each of the code-vectors defining a plurality of pulse positions individually and comprising a plurality of pulses each assignable to the pulse positions of the code-vector, the pulse positions being distributed to a plurality of tracks, said method comprising the steps of:
(a) for each of the pulse positions, evaluating a respective value of a hit function corresponding to said one pulse position;
(b) determining a plurality of pulse combinations in each of the tracks in accordance with the pulse positions and pulses in each of the tracks;
(c) for each of the pulse combinations, evaluating a respective value of a combinational hit function corresponding to said one pulse combination in accordance with the value of the hit function corresponding to each of the pulse positions;
(d) sorting the pulse combinations in each of the tracks in accordance with the value of the combinational hit function corresponding to each of the pulse combinations, in each of the tracks, selecting the pulse combination which has the largest value of the combinational hit function to be a default pulse combination, sorting the other pulse combinations into an ordered sequence in descending order by the values of the combinational hit function;
(e) according to the default pulse combination in each of the tracks, forming a default code-vector and calculating a decision score of the default code-vector;
(f) from the ordered sequence, selecting the next pulse combination to be a candidate pulse combination and to temporarily substitute for the default pulse combination in the same track, forming a candidate code-vector and calculating the decision score of the candidate code-vector; and
(g) according to the decision scores of the candidate code-vector and the default code-vector, performing a code-vector update procedure to determine the target code-vector.

2. The method of claim 1, wherein the code-vector update procedure further comprises the steps of:
(g1) determining if the decision score of the candidate code-vector is less than the decision score of the default code-vector, if YES then performing step (g3), otherwise, proceeding with step (g2);
(g2) substituting the candidate pulse combination for the default pulse combination in the same track, updating the default code-vector with the candidate code-vector; and
(g3) examining if the current search progress satisfies a predetermined search condition, if YES then choosing the default code-vector as the target code-vector and finishing searching.

3. The method of claim 1, wherein the value of the combinational hit function corresponding to one of the pulse combination is the sum of the hit function values of the pulse positions corresponding to said one pulse combination.

4. The method of claim 1, wherein the value of the combinational hit function corresponding to one of the pulse combination is an ordinal number determined by the hit function values of the pulse positions corresponding to said one pulse combination.

5. The method of claim 1 further comprising a threshold, if the value of the combinational hit function corresponding to one of the pulse combination is less than the threshold, said one pulse combination is eliminated from the ordered sequence.

6. The method of claim 1, wherein the ordered sequence comprises a predetermined number of pulse combinations.

7. The method of claim 2, wherein the predetermined search condition is a predetermined number of search iterations.

8. The method of claim 2, wherein the predetermined search condition is a predetermined search time.

9. A system for searching a target code-vector of a speech signal in a speech encoder, the speech signal comprising a plurality of code-vectors, each of the code-vectors defining a plurality of pulse positions individually and comprising a plurality of pulses each assignable to the pulse positions of the code-vector, the pulse positions being distributed to a plurality of tracks, said system comprising:
a first device for evaluating the value of a hit function corresponding to each of the pulse positions;
a second device for determining a plurality of pulse combinations in each of the tracks in accordance with the pulse positions and pulses in each of the tracks;
a third device for evaluating the value of a combinational hit function corresponding to each of the pulse combinations in accordance with the value of the hit function corresponding to each of the pulse positions;
a fourth device for sorting the pulse combinations in each of the tracks in accordance with the value of the combinational hit function corresponding to each of the pulse combinations, in each of the tracks, selecting the pulse combination which has the largest value of the combinational hit function to be a default pulse combination, sorting the other pulse combinations into an ordered sequence in descending order by the values of the combinational hit function;
a fifth device for forming a default code-vector in accordance with the default pulse combination in each of the tracks and calculating a decision score of the default code-vector;
a sixth device for selecting the next pulse combination from the ordered sequence to be a candidate pulse combination and to temporarily substitute for the default pulse combination in the same track, forming a candidate code-vector and calculating the decision score of the candidate code-vector; and
a seventh device for determining the target code-vector in accordance with the decision scores of the candidate code-vector and the default code-vector.

10. The system of claim 9, wherein the seventh device further comprises:
a first module for determining if the decision score of the candidate code-vector is less than the decision score of the default code-vector;
a second module for updating the default code-vector with the candidate code-vector; and
a third module for examining if the current search progress satisfies a predetermined search condition;
wherein said system chooses the default code-vector to be the target code-vector and finishes searching when the current search progress satisfies the predetermined search condition.

11. The system of claim 9, wherein the value of the combinational hit function corresponding to one of the pulse combination is the sum of the hit function values of the pulse positions corresponding to said one pulse combination.

12. The system of claim 9, wherein the value of the combinational hit function corresponding to one of the pulse combination is an ordinal number determined by the hit function values of the pulse positions corresponding to said one pulse combination.

13. The system of claim 9 further comprising a threshold, if the value of the combinational hit function corresponding to one of the pulse combination is less than the threshold, said one pulse combination is eliminated from the ordered sequence.

14. The system of claim 9, wherein the ordered sequence comprises a predetermined number of pulse combinations.

15. The system of claim 10, wherein the predetermined search condition is a predetermined number of search iterations.

16. The system of claim 10, wherein the predetermined search condition is a predetermined search time.
